(19) United States
(12) Patent Application Publication
(10) Pub. No.: US 2019/0325364 A1
(43) Pub. Date: Oct. 24, 2019

(54) SYSTEMS AND METHODS FOR UPGRADING AND RE-ENGINEERING RETAIL SYSTEMS AND APPLICATIONS

(71) Applicants: Badhri Rajagopalan, Lansdale, PA (US); Aparna Ramabhadran, Lansdale, PA (US)

(72) Inventors: Badhri Rajagopalan, Lansdale, PA (US); Aparna Ramabhadran, Lansdale, PA (US)

(21) Appl. No.: 16/393,808

(22) Filed: Apr. 24, 2019

Related U.S. Application Data
(60) Provisional application No. 62/661,919, filed on Apr. 24, 2018.

(51) Int. Cl. G06Q 10/06; G06F 3/0484; G06F 16/17; G06F 9/46

(52) U.S. Cl. CPC G06Q 10/0637; G06F 9/466; G06F 16/1734; G06F 3/0484

(57) ABSTRACT

Systems and methods for upgrading and re-engineering retail systems and applications are provided. The method includes accessing, using one or more graphical user interfaces, a management console of a retail system architecture application, wherein the management console enables a user to access business system integration software of the retail system architecture application, and accessing, using the business system integration software, a current business system architecture for a specific business. The method further includes editing, using the graphical user interface, the current business system architecture, and incorporating, using a processor, the edited business system architecture at one or more touch points, wherein the incorporating is performed using real-time integration.

### CLAIM OF PRIORITY

This application is a United States non-provisional application and claims priority to U.S. Provisional Patent Application No. 62/661,919, Apr. 24, 2018, herein incorporated by reference in its entirety.

### FIELD OF THE EMBODIMENTS

This invention relates to retail management and, in particular, to systems and methods for upgrading and re-engineering retail systems and applications.

### BACKGROUND OF THE EMBODIMENTS

Retail establishments are no longer run on pen and paper. Complicated digital applications and computer programs are used by retailers to help the businesses run efficiently. Creating this digital architecture for a retail establishment or retail chain is costly and time consuming, but the costs do not end with its creation. Editing, upgrading, and re-engineering these applications and programs is also costly and time consuming. Furthermore, retailers lack the ability to upgrade and re-engineer their current systems in the short time available between the peak sale seasons to rapidly respond to changing business needs.

Within the short implementation times available, building a new architecture from the ground up results in lengthy integration project cycles spanning multiple years and resulting in large developmental costs (often reaching in the millions of US dollars). Retailers spend an enormous amount of time and cost with analyzing and identifying customizations and often have to develop data migration strategy from scratch for upgrades. Existing solutions do not handle custom attributes and extensions.

For at least these reasons, a system and method for efficiently creating, upgrading, and re-engineering retail system architectures is needed.

Examples of related art are described below:

U.S. Pat. No. 8,667,387 generally describes a method and system for acquiring and transforming existing content (e.g., Hyper Text Markup Language HTML content) for display and execution on multiple platforms and architectures. In one embodiment, capture templates are created to harvest content from disparate content sources on multiple platforms. Data is extracted from the content from the disparate content sources using the created capture templates that drives extracting process. A standardized data stream is generated from the extracted data. The standardized data stream is provided for display on one or more different type of platforms.

U.S. Pat. No. 8,713,076 generally describes business intelligence, decision support and knowledge management network systems and methods that provide efficient, robust, and business-friendly services for the rapid analysis of massive amounts of business, electronic, and other disparate data into actionable intelligence. An element of the multi-party knowledge network allows the aggregation of common data formats in order to analyze a combined dataset consisting of information from multiple parties, thereby providing additional business intelligence than with a single set of data alone.

U.S. Patent Publication No. 2013/0191418 generally describes business intelligence, decision support and knowledge management network systems and methods that provide efficient, robust, and business-friendly services for the rapid analysis of massive amounts of business, electronic, and other disparate data into actionable intelligence. An advantageous element of the multi-party knowledge network allows the aggregation of common data formats in order to analyze a combined dataset consisting of information from multiple parties, thereby providing additional business intelligence than with a single set of data alone.

U.S. Patent Publication No. 2013/0211556 generally describes systems and methods of monitoring, analyzing, optimizing and controlling data centers and data center operations. The system includes data collection and storage hardware and software for harvesting operational data from data center assets and operations. Intelligent analysis and optimization software enables identification of optimization and/or control actions. Control software and hardware enables enacting a change in the operational state of data centers.

U.S. Patent Publication No. 2014/0143395 generally describes methods that include a machine-to-machine (“M2M”) rules management system associated with an M2M platform 1) processing a plurality of events associated with one or more M2M objects in substantially real-time as the events occur over a period of time, 2) receiving, while the events are being processed in substantially real-time, data representative of a rule created by a user associated with the M2M platform, and 3) dynamically applying, in response to receiving the data representative of the rule, the rule to the substantially real-time processing of the events. Corresponding methods and systems are also described.

U.S. Patent Publication No. 2016/0071212 generally describes contemporaneous evaluation of structured and unstructured data on a single integrated platform, facilitating the creation and implementation of investment strategies. Functionality includes the ability to modify data with a variety of statistical and mathematical operations, and the saving, exporting, and sharing of analyses. It is additionally possible to set up alerts, translate analyses into trading instructions for market brokers, include additional datasets, and generate parameters for predictive analytics. Function calls can be processed manually or in a batch mode, and events can be imposed to occur sequentially within specified timeframes as pre-conditions for investment actions being taken. Preferred performance profiles can be expanded so as to permit an automated process of identifying opportunities among alternative investments.

U.S. Patent Publication No. 2016/0267516 generally describes a computer-implemented method for providing mobile loyalty services in a geo-fencing area via a native mobile application a location of a mobile device is determined in a geo-fencing area via a native mobile application executing on the mobile device. Mobile payment is provided via the mobile device through the native mobile application. Mobile marketing is provided at the mobile device by the native mobile application, wherein the mobile marketing is based on the location of the mobile device in the geo-fencing area.

None of the art described above addresses all of the issues that the present invention does.

### SUMMARY OF THE EMBODIMENTS

According to an aspect of the present invention, a method for upgrading and re-engineering retail systems and applications is provided. The method includes accessing, using one or more graphical user interfaces, a management console of a retail system architecture application, wherein the management console enables a user to access business system integration software of the retail system architecture application, and accessing, using the business system integration software, a current business system architecture for a specific business. The method further includes editing, using the graphical user interface, the current business system architecture, and incorporating, using a processor, the edited business system architecture at one or more touch points, wherein the incorporating is performed using real-time integration.

According to another aspect of the present invention, a system for upgrading and re-engineering retail systems and applications is provided. The system includes a memory configured to house one or more current business system architectures and any edits to the one or more current business system architectures, and a graphical user interface, configured to enable a user to: access a management console of a retail system architecture application, the retail system architecture application being housed in the memory, wherein the management console enables a user to access business system integration software of the retail system architecture application; access, using the business system integration software, a current business system architecture for a specific business; and edit the current business system architecture. The system further includes a processor configured to incorporate the edited business system architecture at one or more touch points, wherein the processor incorporates the edited business system architecture using real-time integration.

It is an object of the present invention to provide the method for upgrading and re-engineering retail systems and applications, wherein the editing includes accessing and editing information housed in one or more remote servers.

It is an object of the present invention to provide the method for upgrading and re-engineering retail systems and applications, wherein the incorporating the edited business system architecture is performed while the current business system architecture is still running.

It is an object of the present invention to provide the method for upgrading and re-engineering retail systems and applications, wherein the method further includes storing and logging any error messages during integration.

It is an object of the present invention to provide the method for upgrading and re-engineering retail systems and applications, wherein the editing and incorporating steps include performing one or more transactions, wherein each transaction refers to a change in the current business system architecture.

It is an object of the present invention to provide the method for upgrading and re-engineering retail systems and applications, wherein each transaction performed in the editing and incorporating steps is assigned a transaction identification.

It is an object of the present invention to provide the method for upgrading and re-engineering retail systems and applications, wherein each transaction identification is stored in a system database.

It is an object of the present invention to provide the method for upgrading and re-engineering retail systems and applications, wherein the editing the current business system architecture further includes creating a new business system architecture.

It is an object of the present invention to provide the method for upgrading and re-engineering retail systems and applications, wherein the editing the current business system architecture further includes editing existing business system architectures.

It is an object of the present invention to provide the method for upgrading and re-engineering retail systems and applications, wherein the touch points are selected from the group consisting of: a store; a call center; a smart television; an SMS-capable electronic device; a social media platform; a website; a market place; a smart phone; a kiosk; and a print catalog.

It is an object of the present invention to provide the system for upgrading and re-engineering retail systems and applications, wherein the system further includes one or more remote server, and wherein the processor is further configured to enable the user to access and edit information housed in the one or more remote servers.

It is an object of the present invention to provide the system for upgrading and re-engineering retail systems and applications, wherein the processor is further configured to incorporate the edited business system architecture is performed while the current business system architecture is still running.

It is an object of the present invention to provide the system for upgrading and re-engineering retail systems and applications, wherein the memory is further configured to store and log any error messages during integration.

It is an object of the present invention to provide the system for upgrading and re-engineering retail systems and applications, wherein the editing and incorporating steps include performing one or more transactions, wherein each transaction refers to a change in the current business system architecture.

It is an object of the present invention to provide the system for upgrading and re-engineering retail systems and applications, wherein each transaction performed in the editing and incorporating steps is assigned a transaction identification.

It is an object of the present invention to provide the system for upgrading and re-engineering retail systems and applications, wherein each transaction identification is stored in the memory.

It is an object of the present invention to provide the system for upgrading and re-engineering retail systems and applications, wherein the graphical user interface is further configured to enable the user to create a new business system architecture.

It is an object of the present invention to provide the system for upgrading and re-engineering retail systems and applications, wherein the graphical user interface is further configured to enable the user to edit existing business system architectures.

It is an object of the present invention to provide the system for upgrading and re-engineering retail systems and applications, wherein the touch points are selected from the group consisting of: a store; a call center; a smart television; an SMS-capable electronic device; a social media platform; a website; a market place; a smart phone; a kiosk; and a print catalog.

### BRIEF DESCRIPTION OF THE DRAWINGS

FIG. 1 shows a Repeatable Retail Integration Architecture (RRIA) model, according to an embodiment of the present invention.

FIG. 2 shows a system for upgrading and/or re-engineering retail system architectures, according to an embodiment of the present invention.

FIGS. 3-4 show a method for upgrading and/or re-engineering retail system architecture, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

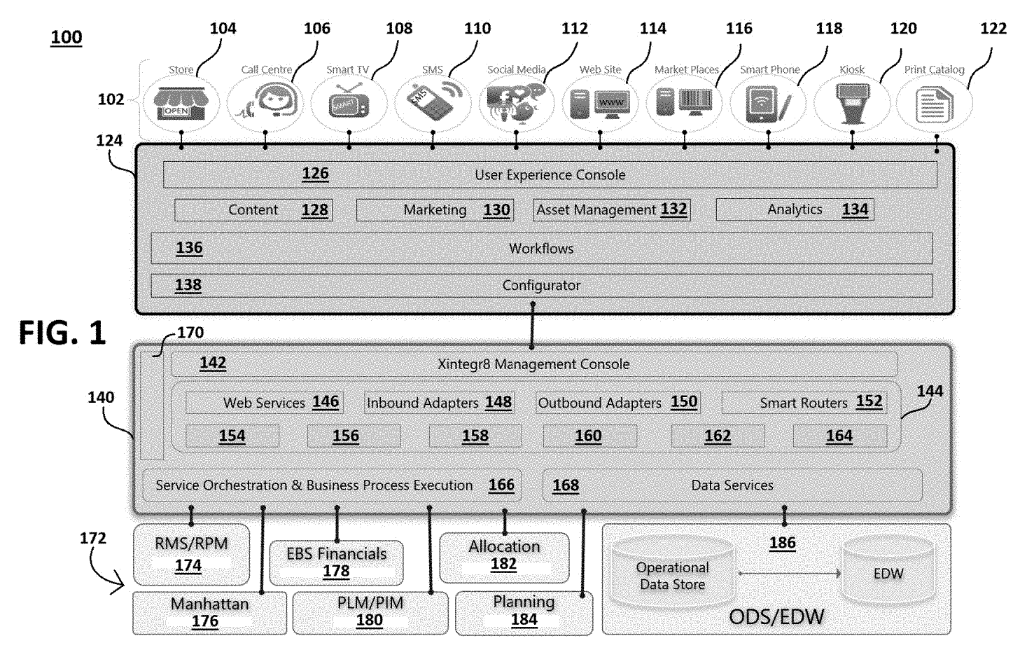

Referring now to FIG. 1, a Repeatable Retail Integration Architecture (RRIA) model 100 is illustratively depicted, in accordance with an embodiment of the present invention.

According, to an embodiment, the RRIA model 100 is based on Service-Oriented Architecture (SOA) principles. The RRIA model 100, being repeatable, enables users to quickly and efficiently edit existing retail system architecture and create new retail system architecture. By integrating repeatability, users have a jumpstart in applying integrations to retail applications, resulting in a significant reduction in the time and costs associated in implementation of retail system architecture.

According to an embodiment, the RRIA model 100 is configured to control and/or edit one or more touch points 102, which are possible points of contacts between the retail seller and the consumer. According to an embodiment, the touch points 102 may include, but are not limited to, one or more physical stores 104, one or more call centers 106, one or more smart TVs 108, one or more SMS-receiving devices 110, one or more social media networks/accounts 112, one or more websites 114, one or more marketplaces 116, one or more smartphones and/or similar devices 118, one or more kiosks 120, one or more print catalogues 122, and/or any other suitable touch point 102.

According to an embodiment, the RRIA model 100 includes an integration layer 140 coupled to the CX/UX layer 124. According to an embodiment, the integration layer 140 includes a management console 142 (also referred herein as a Xintegr8 management console 142 due to the multiple supporting layers). According to an embodiment, the management console 142 includes a graphical user interface enabling a user to access one or more components of the RRIA model 100. According to an embodiment, the programming of the RRIA model 100 includes a business system integration platform with which users can integrate changes into business system architectures and/or create business system architectures. According to an embodiment, the management console 142 is configured to enable a user to operate the business system integration platform.

According to an embodiment, the integration layer 140 further includes a business services layer 144. According to an embodiment, the business services layer 144 includes applications and functions pertaining to one or more business services and may include, but is not limited to, web services 146, inbound adapter services 148, outbound adapter services 150, smart router services 152, error message services 154, audit services 156, meta-data services 158, notification services 160, archival services 162, retry function services 164, and/or any other suitable business services.

According to an embodiment, the integration layer 140 further includes a service orchestration and business process execution layer 166. According to an embodiment, the service orchestration and business process execution layer 166 includes services and/or components configured to build the various services necessary for the efficient running of the RRIA model 100.

According to an embodiment, the integration layer 140 includes one or more data services 168, which may include modeled data, archived data, one or more programming components, memory, etc. According to an embodiment, the integration layer 140 further includes a security layer 170 configured to secure access, programming, and/or other data associated with the RRIA model 100.

According to an embodiment, the RRIA model 100 is programmed to include one or more pre-defined transformation templates. According to an embodiment, these templates are related to the formation and/or transformation/editing of retail system architectures. However, it is noted that the present RRIA model 100 may be used in conjunction with other suitable business system architectures. The pre-defined transformation templates decrease the time and cost needed to create and/or alter business system architectures, enabling users to more efficiently run their business system architectures with the changing business climate, which is an improvement upon the existing technologies.

According to an embodiment, the management console 142 is configured to create and/or edit business system architecture in both batch and real time formats. According to an embodiment, the management console 142 is configured to edit business system architectures using real-time integration. The various integration methods that can be implemented with the present invention enable business management to more efficiently, and cost-effectively, create business system architectures and/or integrate new programming into already existing business system architectures.

According to an embodiment, the RRIA module 100 can be in contact with one or more remote servers and/or devices via a wired and/or wireless connection. According to an embodiment, the RRIA model 100 is capable of cloud computing.

Business system architectures, while running, will occasionally have errors. According to an embodiment, the management console 142 is configured to store and log errors messages. These error messages may be accessible to a user using the error messages services 154 function. According to an embodiment, the management module 142 creates a queue of some or all transactions that have an error log and reprocesses each transaction that has an error log at least once in an attempt to alleviate the error. According to an embodiment, the management console 142 is configured to enable a user to customize the error logging that captures transaction-specific meta-data in the database saved in the data services layer 168. According to an embodiment, the management module 142 tracks every transaction processed and assigns each transaction with a transaction identification (a “TxID”), which is subsequently logged in a database table of the present system (shown in FIG. 1).

According to an embodiment, not all functions of the management console 142 are accessible to every user. According to an embodiment, the management console 142 determines which functions are accessible to a user and, upon logging into the management console 142, only those functions accessible to the user are enabled.

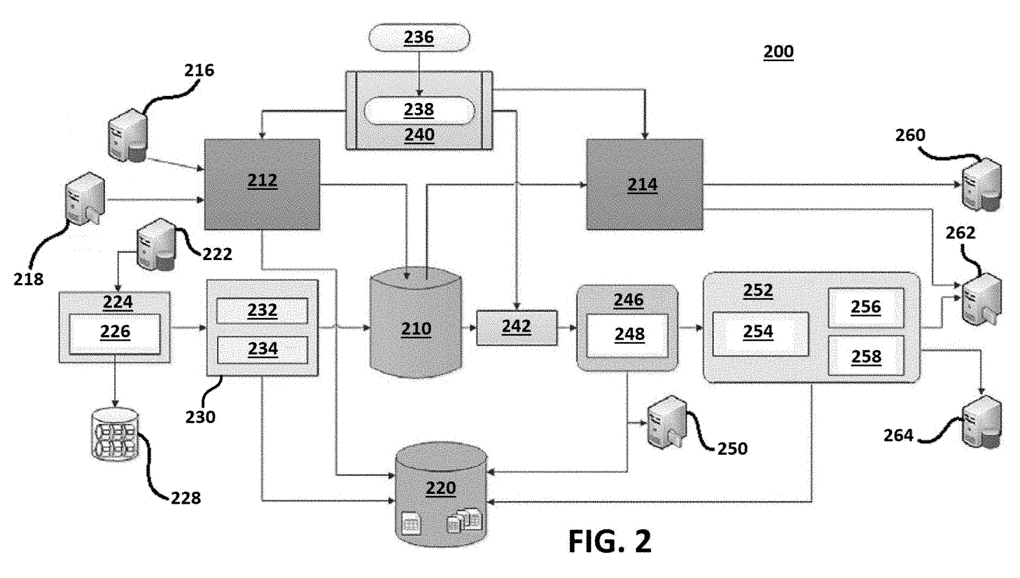

According to an embodiment, one or more external layers and/or modules may be coupled to the layers of the RRIA model 100 via a back office layer 172, coupled to the integration layer 140. The back office layer 172 may include, e.g., retail merchandising programming (e.g., Oracle's Retail Merchandising System (RMS) and Remote Preemptive Monitor (RPM)) 174, distribution management systems (e.g., Manhattan Associates' PKMS and open systems) 176, business management software 178 (e.g., Oracle's EBS Financial software or TradeStone Software), product lifecycle management (PLM) software and/or personal information manager (PIM) software 180, software and/or hardware allocation software 182, business planning software 184, a data layer 186 and/or any other relevant layers and/or modules such as, but not limited to, a warehouse management and/or marketing (e.g., JDA/SAS/E3) layer, a legacy layer, etc. According to an embodiment, the legacy layer includes any current business programming and/or current business system architecture. According to an embodiment, the data layer 186 includes an Operational Data Store (ODS) 210 (shown in FIG. 2) coupled to an Enterprise Data Warehouse (EDW) for data analysis.

According to an embodiment, one or more of the functions of the RRIA model 100 may be performed by any suitable electronic computing device including a processor and a memory, wherein the processor may perform one or more of the functions, services, etc. of the RRIA model 100.

According to an embodiment, the RRIA model 100 incorporates a data migration toolkit that can accommodate base data and which will reduce the complexity of upgrades and will also reduce the time and effort needed to design and implement upgrades, which decreases overall costs. According to an embodiment, this data migration toolkit also supports custom attributes and extensions and minimizes risk and accelerates timelines and increases success quotients.

According to an embodiment, the RRIA model's 100 data migration toolkit is configured to handle data migration for systems such as Oracle Retail Merchandising System (ORMS). According to an embodiment, the data migration toolkit maps the existing data and migrates that data into a newer version of ORMS. According to an embodiment, the data migration toolkit is configured to speed up version upgrades so that a retailer is aligned and current with the Oracle Application upgrade path.

According to an embodiment, the data migration toolkit is configured to handle base data entities out of the box and maintains focus only on changed data entities. An out-of-the-box accelerator can be extended to include Retailer's customizations and extensions with minimal effort, reducing data migration and conversion time and effort, thus reducing costs, which is an improvement upon the existing technologies.

Referring now to FIG. 2, a system 200 for upgrading and/or re-engineering retail system architectures is illustratively depicted, in accordance with an embodiment of the present invention.

According to an embodiment, the ODS 210 is coupled to one or more first Open Data-Link Interfaces (ODIs) 212, and one or more second ODIs 214. One or more servers (e.g., one or more database servers 216, one or more file servers 218, etc.) are coupled to the first ODI 212, which is configured to send data to the ODS 210 and one or more databases 220.

According to an embodiment, an RMS Retail Integration Bus (RIB) server 222 is coupled to a service bus 224 that enables RMS RIB subscribers 226 to access and store data in a source file archival database 228. According to an embodiment, the OSB 224 is further coupled to an OSB routing module 230 housing smart router proxy services 232 and transformation services 234. According to an embodiment, the OSB routing module 230 is coupled to the ODS 210, enabling the RMS RIB server 222 to be coupled to the ODS 210 through the OSB 224 and the OSB Routing module 230. According to an embodiment, the OSB Routing module 230 is further coupled to one or more databases 220.

An Enterprise Scheduler 236 is configured to trigger a common trigger svc 238 within a secondary OSB 238. According to an embodiment, the secondary OSB 238 is coupled to the at least one first ODI 212, the at least one second ODI 214, and to an OSB smart router 242, which is coupled to the ODS 210. The second ODI 214 may further be coupled to a second database server 260 and a second file server 262.

According to an embodiment, the OSB smart Router 242 is further coupled to a Service-Oriented Architecture (SOA) transformation services module 246. According to an embodiment, the SOA Transformation Services module 246 may incorporate an XML native format conversion services module 248.

According to an embodiment, the SOA Transformation services module 246 is further coupled to a local SOA file share server 250 and the at least one database 220. The SOA Transformation Services module 246 may further be coupled to an OSB delivery module 252, which may house a smart router delivery proxy 254, topic/queue publishers 256, and file folder outbound adapters 258.

According to an embodiment, the OSB delivery module 252 may further be coupled to the second file server 262, an RMS server 264, and the at least one database 220.

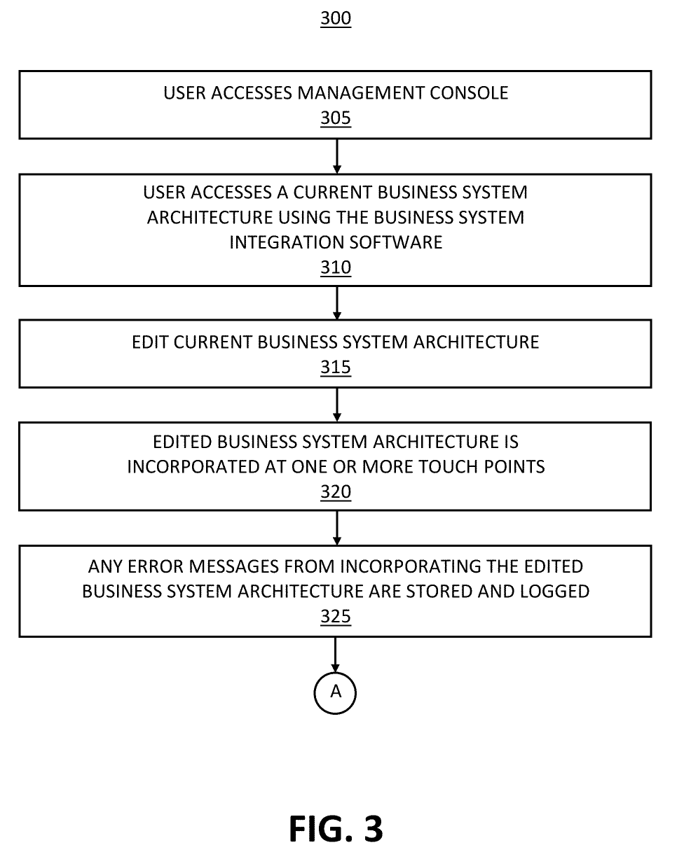

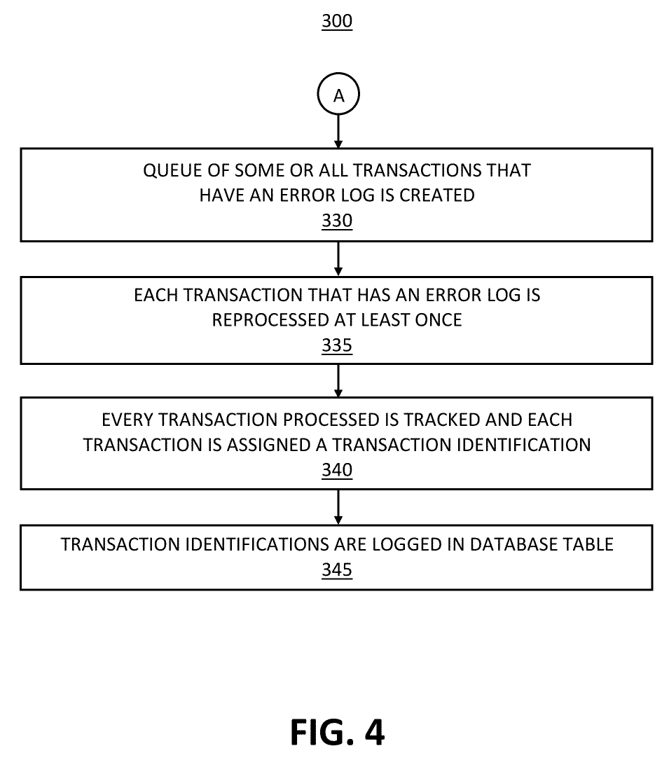

Referring now to FIGS. 3-4, a method 300 for upgrading and/or re-engineering retail system architecture is illustratively depicted, in accordance with an embodiment of the present invention.

At step 305, a user accesses the management console of a retail system architecture application being run on a suitable electronic computing device. According to an embodiment, the management console enables a user to access business system integration software of the retail system architecture application.

At step 310, the user accesses a current business system architecture using the business system integration software. According to an embodiment, the current business system architecture is accessing on a graphical user interface of the suitable electronic computing device.

At step 315, the current business system architecture is edited using the graphical user interface. According to an embodiment, the editing includes accessing and editing information housed in one or more remote servers.

At step 320, the edited business system architecture is incorporated at one or more touch points. According to an embodiment, the edited business system architecture is incorporated using real-time integration, enabling the business system architecture to be updated while in use and/or running, reducing the time and costs typically needed for updating business system architectures, thus improving upon the existing technology. According to an embodiment, the editing the current business system architecture further includes creating a new business system architecture. According to another embodiment, the editing the current business system architecture further includes editing existing business system architectures.

Business system architectures, while running, will occasionally have errors. According to an embodiment, at step 325, any errors messages are stored and logged. These error messages may be accessible to a user using an error messages services function.

According to an embodiment, the editing and incorporating steps include performing one or more transactions, wherein each transaction refers to a change in the current business system architecture. According to an embodiment, at step 330, a queue of some or all transactions that have an error log is created and, at step 335, each transaction that has an error log is reprocessed at least once in an attempt to alleviate the error. According to an embodiment, the management console is configured to enable a user to customize the error logging that captures transaction-specific meta-data in the database saved in the data services layer.

According to an embodiment, the management module, at step 340, tracks every transaction processed and assigns each transaction with a transaction identification (a “TxID”), which, at step 345, is subsequently logged in a database table of the present system.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Vertex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invnetion.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_ambient_temperature, and/or the like. A Parameter table may include fields including the foregoing fields, or additional ones such as cool start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for upgrading and re-engineering retail systems and applications, comprising:
accessing, using one or more graphical user interfaces, a management console of a retail system architecture application,
wherein the management console enables a user to access business system integration software of the retail system architecture application;
accessing, using the business system integration software, a current business system architecture for a specific business;
editing, using the graphical user interface, the current business system architecture; and
incorporating, using a processor, the edited business system architecture at one or more touch points,
wherein the incorporating is performed using real-time integration.

2. The method as recited in claim 1, wherein the editing includes accessing and editing information housed in one or more remote servers.

3. The method as recited in claim 1, wherein the incorporating the edited business system architecture is performed while the current business system architecture is still running.

4. The method as recited in claim 3, further comprising storing and logging any error messages during integration.

5. The method as recited in claim 1, wherein the editing and incorporating steps include performing one or more transactions, wherein each transaction refers to a change in the current business system architecture.

6. The method as recited in claim 5, wherein each transaction performed in the editing and incorporating steps is assigned a transaction identification.

7. The method as recited in claim 6, wherein each transaction identification is stored in a system database.

8. The method as recited in claim 1, wherein the editing the current business system architecture further includes creating a new business system architecture.

9. The method as recited in claim 1, wherein the editing the current business system architecture further includes editing existing business system architectures.

10. The method as recited in claim 1, wherein the touch points are selected from the group consisting of: a store; a call center; a smart television; an SMS-capable electronic device; a social media platform; a website; a market place; a smart phone; a kiosk; and a print catalog.

11. A system for upgrading and re-engineering retail systems and applications, comprising:
a memory configured to house one or more current business system architectures and any edits to the one or more current business system architectures;
a graphical user interface, configured to enable a user to:
access a management console of a retail system architecture application, the retail system architecture application being housed in the memory,
wherein the management console enables a user to access business system integration software of the retail system architecture application;
access, using the business system integration software, a current business system architecture for a specific business; and
edit the current business system architecture; and
a processor configured to incorporate the edited business system architecture at one or more touch points,
wherein the processor incorporates the edited business system architecture using real-time integration.

12. The system as recited in claim 11, further comprising one or more remote server, and
wherein the processor is further configured to enable the user to access and edit information housed in the one or more remote servers.

13. The system as recited in claim 11, wherein the processor is further configured to incorporate the edited business system architecture is performed while the current business system architecture is still running.

14. The system as recited in claim 13, wherein the memory is further configured to store and log any error messages during integration.

15. The system as recited in claim 11, wherein the editing and incorporating steps include performing one or more transactions, wherein each transaction refers to a change in the current business system architecture.

16. The system as recited in claim 15, wherein each transaction performed in the editing and incorporating steps is assigned a transaction identification.

17. The system as recited in claim 16, wherein each transaction identification is stored in the memory.

18. The system as recited in claim 11, wherein the graphical user interface is further configured to enable the user to create a new business system architecture.

19. The system as recited in claim 11, wherein the graphical user interface is further configured to enable the user to edit existing business system architectures.

20. The system as recited in claim 11, wherein the touch points are selected from the group consisting of: a store; a call center; a smart television; an SMS-capable electronic device; a social media platform; a website; a market place; a smart phone; a kiosk; and a print catalog.
